(19) United States
(12) Patent Application Publication
(10) Pub. No.: US 2025/0390946 A1
(43) Pub. Date: Dec. 25, 2025

(54) Distributed Digital Lending (LoanChain) Global matching of lenders and borrowers

(71) Applicant: Gideon Samid, Rockville, MD (US)

(72) Inventor: Gideon Samid, Rockville, MD (US)

(21) Appl. No.: 19/268,130

(22) Filed: Jul. 14, 2025

Related U.S. Application Data
(63) Continuation-in-part of application No. 18/752,303, filed on Jun. 24, 2024.
(60) Provisional application No. 63/697,576, filed on Sep. 22, 2024.
(60) Provisional application No. 63/749,666, filed on Jan. 26, 2025.
(60) Provisional application No. 63/759,229, filed on Feb. 16, 2025.
(60) Provisional application No. 63/781,339, filed on Mar. 31, 2025.
(60) Provisional application No. 63/828,891, filed on Jun. 23, 2025.

(51) Int. Cl. G06Q 40/03

(52) U.S. Cl. CPC G06Q 40/0305

(57) ABSTRACT

Establishing an AI empowered global loan matching of borrowers and lenders, by creating a loanchain of “atomic loans”. Large long duration loans are constructed from a succession of small, short duration loans, thereby mitigating lender's risk, and pulling into the loan dynamics hundreds of billions of dollars that currently earn no interest to their owners.

Continuation in Part of U.S. patent application Ser. No. 18/752,303 filed Jun. 24, 2024
This application is also a continuation in parts of application Ser. No. 17/862,285 filed Jul. 11, 2022 which claims benefit of Provisional Application 63/276,662 filed Nov. 8, 2021.
This application is also a continuation in parts of application Ser. No. 17/207,694. This application is also a continuation in part of application Ser. No. 15/582,784 filed May 1, 2017. This application is also a continuation in part of U.S. patent application Ser. No. 14/352,994, filed on Apr. 18, 2014 as national stage application of PCT/US2012/061331, filed on Oct. 22, 2012, which claims the benefit of U.S. Provisional Patent Application Ser. No. 61/627,977, filed Oct. 22, 2011 and U.S. Provisional Patent Application No. 61/688,788, filed May 22, 2012.
This application is also a continuation-in-part of U.S. patent application Ser. No. 15/337,203, filed Oct. 28, 2016, which is a continuation of U.S. patent application Ser. No. 14/737,924, filed Jun. 12, 2015, which is a continuation of U.S. patent application Ser. No. 13/529,399, filed Jun. 21, 2012, which is a continuation of U.S. patent application Ser. No. 12/081,412, filed Apr. 15, 2008, now U.S. Pat. No. 8,229,859, which claims the benefit of U.S. Provisional Patent Application Ser. No. 60/960,672, filed Oct. 9, 2007 and U.S. Provisional Patent Application No. 60/907,869, filed Apr. 19, 2007,
This application claims the benefit of U.S. Provisional Applications 63/641,398 filed May 1, 2024 and U.S. Provisional Application 63/663,214 filed on 2024 Jun. 24
This application claims the benefit of U.S. Provisional Application 63/697,576 filed on Sep. 22, 2024, Provisional Application 63/749,666 filed Jan. 26, 2025. U.S. Provisional Application 63/759,229 filed Feb. 16, 2025, U.S. Provisional Application 63/781,339 filed on Mar. 31, 2025, U.S. Provisional Application 63/828,891 filed on Jun. 23, 2025,
all of which are incorporated by reference in their entireties.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

Digital money enables instant payment from across the globe, no need for post payment settlement. This attribute of payment in cyber space may be exploited in many ways and enable payment solutions that were not available before. This Application exploits this instant finite payment to build up an elaborate global loan matching solution where lenders from all corners of the globe lend money to borrowers from all across.

### BRIEF SUMMARY OF THE INVENTION

Money (unlike a hammer or. a car) is useless except when paying it off. Why then not lend it (and claim interest) until payment is due? Presenting a method to accomplish this vision. The dynamics of society is enabled, in large part, through an efficient matching between people who have money to lend and people who have a need to borrow. Fair loans serve both the lender and the borrower. This task is handled today mostly via traditional banks. They offer various plans to depositors from whence they serve borrowers. Proposing to replace such rigidity with cyberspace-rooted dynamic ad-hoc global matching of lenders and borrowers. Uniquely here we build a chain of lenders to support a single borrower as well a chain of borrowers to feed off a single lender. Lenders will post a proposition to lend a given amount of money for a stated duration for a pre-agreed interest rate. Borrowers will post a request to borrow a desired amount of money, for a specified duration, and for which they are ready to pay a stated interest. A virtual digital bank (VDB), a Loan-Match-Maker, (LMM) will match the posts, negotiate terms as necessary, and move the money—everyone benefits. Distributed Digital Lending, DDL, applies to macro, long terms loans, as well as to micro. very short terms loans. DDL efficiency will ensure that most of money at rest will be money in growth, and the full global lending capacity will be put to good service through the exact loans borrowers want. DDL is hinged in digital transactions which are immediate, irrevocable, and private, per regulatory allowance. The matching is optimized with AI tools. BitMint*Le VeL is the design standard coin for DDL, but other digital money options will do too.

### Distributed Digital Lending (LoanChain)

Global matching of Lenders and Borrowers

### SPECIFICATIONS

Overview: The dynamics of society is enabled, in large part, through an efficient matching between people who have money to lend and people who have a need to borrow. Fair loans serve both the lender and the borrower. This task is handled today mostly via traditional banks. They offer various plans to depositors from whence they serve borrowers. Proposing to replace such rigidity with cyberspace-rooted dynamic ad-hoc global matching of lenders and borrowers. Uniquely here we build a chain of lenders to support a single borrower as well a chain of borrowers to feed off a single lender. Lenders will post a proposition to lend a given amount of money for a stated duration for a pre-agreed interest rate. Borrowers will post a request to borrow a desired amount of money, for a specified duration, and for which they are ready to pay a stated interest. A virtual digital bank (VDB) will match all the posts, negotiate terms as necessary, and move the money—everyone benefits. Distributed Digital Lending, DDL, applies to macro, long terms loans, as well as to micro. very short terms loans. DDL efficiency will ensure that most of money at rest will be money in growth, and the full global lending capacity will be put to good service through the exact loans borrowers want. DDL is hinged in digital transactions which are immediate, irrevocable, and private, per regulatory allowance. The matching is optimized with AI tools. BitMint*Le VeL is the design standard coin for DDL, but other digital money options will do too.

### 0. BRIEF EXPLANATION OF DRAWINGS

FIG. 1. Matching large borrowers with small lenders

The figure shows the digital lending initiative, DLI handling a set of large sum long duration borrower to be matched with a large number of small sum short duration lenders (note that here we use DLI or alternatively virtual digital bank, VDB, or ‘loan match maker’ all referring to the organization that offers this loan matching option to the public). In this case, which is expected to be common one, the task will be to put together an array of small scale lenders to meet the requirements of a smaller number of large scale borrowers.

FIG. 2. Matching large lenders with small borrowers

This figure shows the case where people with large amount of money to put aside are offering large loans for long duration while on the other side the borrowers are asking for smaller loans for shorter durations. The task of the DLI is to build a puzzle so to speak to match the small loan requests with the large lending offering, the DLI procedure for this matching is symmetrically equivalent to the matching of small lenders to large borrowers. the matching starts with the most close time point and then adjusts the sums.

FIG. 3 Three short term lenders serve one long term borrower

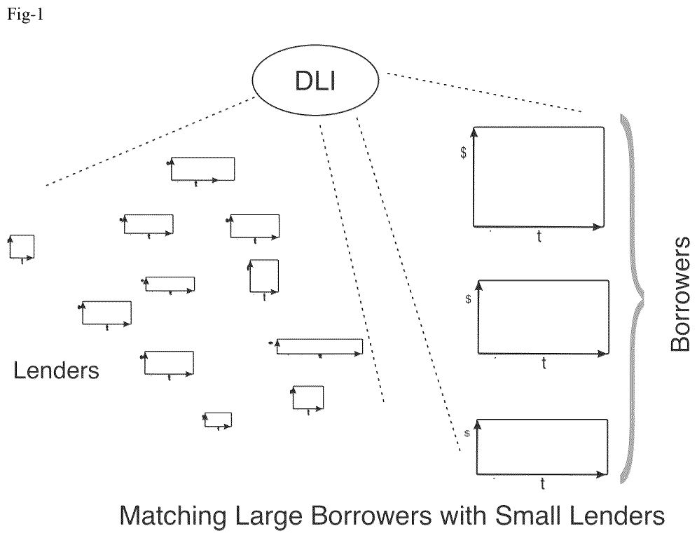

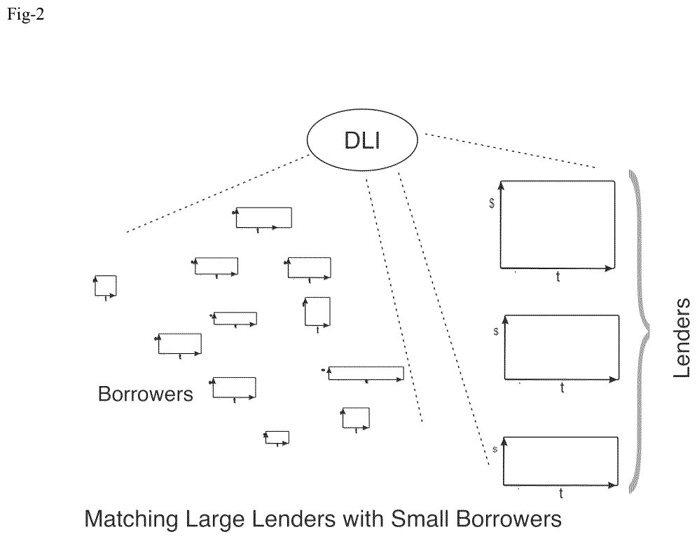

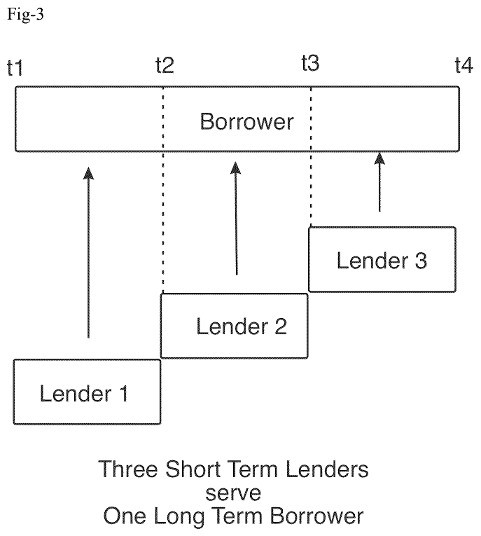

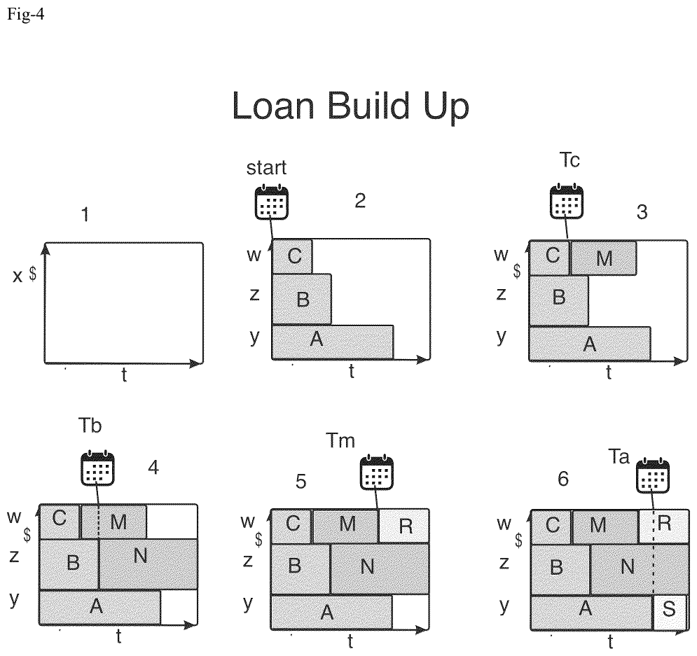

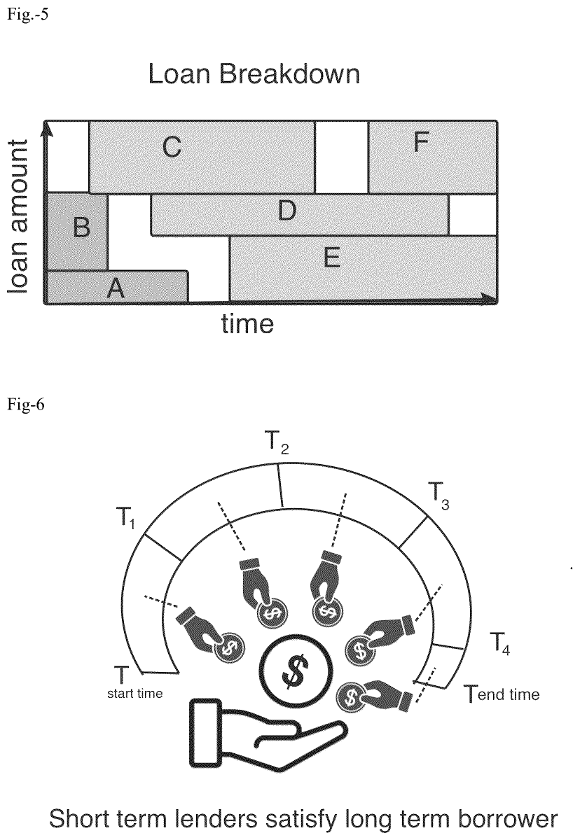

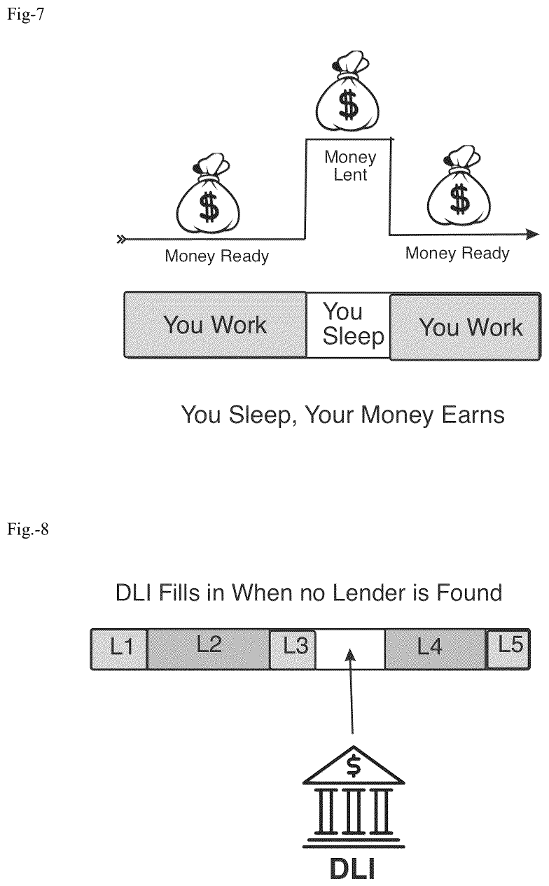

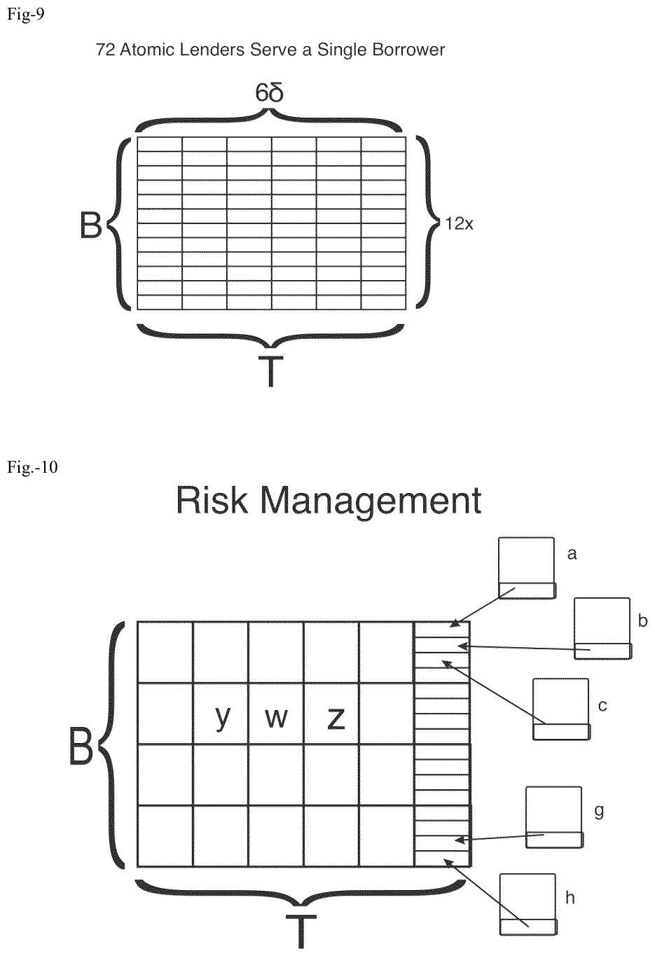

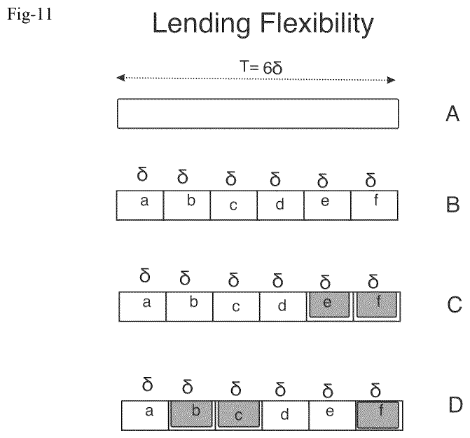

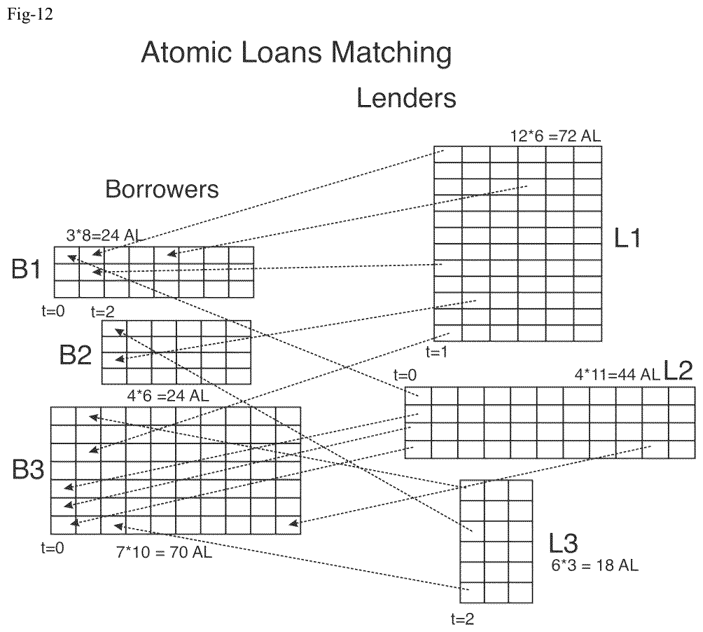

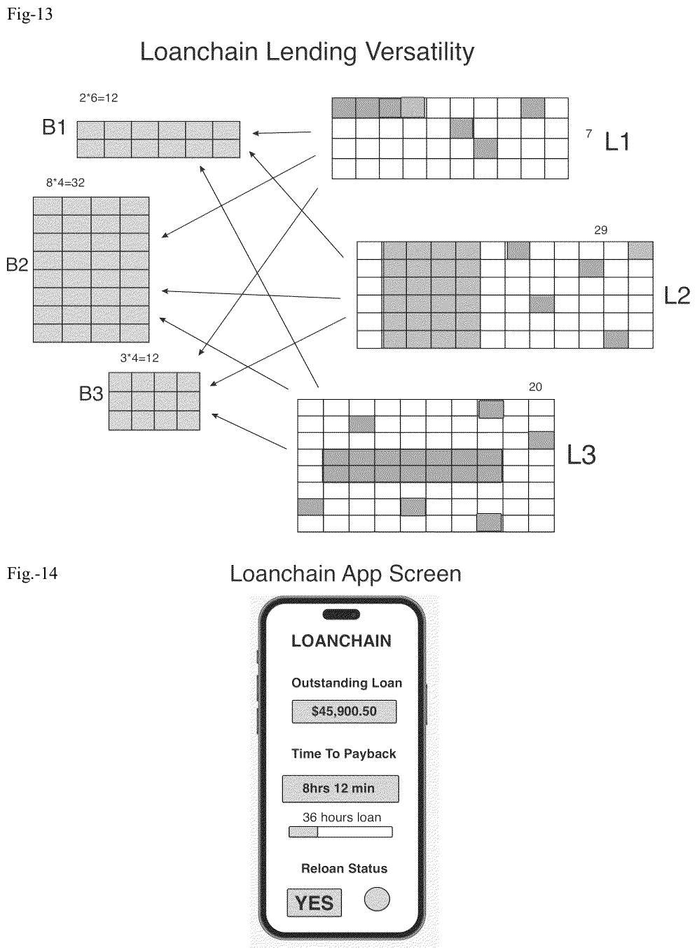

The figure shows a borrower who accepts a loan at date and time, t1 and is returning the loan at time point t4. The interest payment of the borrower is not shown on the figure. The figure shows that lender 1 transfers BitMint money to the borrower (the amount of the loan) at time point t1. At time point t2 lender 2 comes in and pays the amount of the loan to lender 1. This completes the participation of lender 1 in the loan event. Lender 1 offered the sum of the loan for the period t1 to t2. They received their money and our out of the situation. The borrower is not asked to pay anything so the borrower is blind to the fact that lender 2 paid to lender 1 the amount of the loan. When the clock reaches time/date t3, lender 3 comes in and pays the amount of the loan to lender 2. Again the borrower is blind to this exchange. Lender 2 receives the loan amount after the agreed upon time t3−t2. Now the borrower is served by lender 3. When the clock hits t4 the borrower is expected to pay the amount of the loan back to lender 3 which gets its money when expected. We note that while it is possible that all these transactions are done directly between lenders and borrowers, it is more orderly to have the DLI as an intermediary to whom the BitMint coins are paid and who pays the BitMint coins to the participants. The borrower at some preset time remits to the DLI the calculated amount of interest based on the agreed interest rate. the amount of the loan, and its duration. The DLI collects this payment with all other payments by the various borrowers, uses the money for operation and profits and pays the money due per agreement to the lender 3.

FIG. 4 Loan Buildup

This figure shows a borrowing request for an amount x$ asked for duration t as it is being gradually built up from smaller scale lenders. (1). There was no lender offering the full sum of $x, so the DLI had to break down x to smaller parts to fits the sums the lender specified in their postings. The sum x was broken down in this case to sums y, z, and w that together amount to x:

$$x = y + z + w$$

Lender A was matched with the borrower to pay to them the amount y. Lender B was matched with the same borrower to take care of a partial sum z and lender C who offered to lend an amount W was also matched up. So on the date and time that loan event is scheduled to start, lender A, B and C together are paying y, z, and w sums (summing up to x) to the borrower and the loan event starts its life cycle. The borrower has no clue that three lenders had to be assembled to service their loan, and the borrower does not care. (2)

When the clock ticks time Tc (later of course then the start time), the involved lender C is expected to get its loan back. (3). The DLI was busy all the time until Tc to find a suitable lender to replace lender C. Fortunately the DLI found lender M that offered to lend an amount w (or higher) and agrees for the loan to start at time point Tc. Lender M then pays the mount w to lender C, and lender C leaves the scene having accomplished his plan to lend an amount w for the period of time to start at ‘start’ time and end on Tc.

Then the clock runs forward and Tb becomes the time of the present. (4). At Tb lender B is expecting to be paid his loan in the amount of z. The DLI before that moment was able to locate lender N who is ready to lend the amount z, and indeed is paying that sum to lender B (again the payment is in all convenience done from lender N to the DLI which right away passes it to lender B—but direct transfer of money N to B is also possible, if so desired.

Next critical time comes when the clock runs its course to time point Tm (5). At this point lender M who at time point Tc paid w$ to lender C is expecting to be paid back the same amount now at time point Tm. This happens because the DLI found lender R who offered to pay the amount w or higher and do so beginning at time point Tm. So lender R is paying lender M, and lender M leaves the scene, fully satisfied.

Next the clock arrives to time point Ta (6). Lender A was the longest duration lender from the first set (lender A, B, and C). Lender A was prepared to lend to time point Ta which is still short of the full loan duration, so the DLI had to find lender S to pay the amount y$ to lender A, and again the borrower is clueless. When the clock comes to the end of the loan duration, t, then the borrower is returning the amount of the loan x to DLI (as said the interest payment is handled separately), and DLI breaks down x to y, z and w, and pays lender S the amount y, pays lender N the amount z and pays lender R the amount w.

This finishes off the loan event. A good match was achieved. The borrower got the money they requested at the amount and duration they requested and was agreed upon between them and the DLI, and when the loan time concluded the borrower returned the same amount x to DLI which was then able to satisfy lender N, S, and R.

FIG. 5 Loan Breakdown

This figure shows breakdown of a large lending offer to assorted smaller borrowing requests. Borrowers, A, B, C, D, E, and F are all fitted into the block of the lender offer. Each for a certain amount of money and a certain stretch of time. The white area represent lending capacity for which no match was found.

FIG. 6 short term lenders satisfy long term borrower

Five lender are shown to replace each other at time T1, T2, T3, T4 as together they match the borrower's request.

FIG. 7 You Sleep, your money earns

This figure depicts a use of the DLI for businesses or individuals who wish to keep their liquid assets spend-ready when they are active and awake, but are prepared to lend that money off during after hours, over night, or say when they are sleeping. After all a sleeping person is not spending any money. So the “bag of money” is shown at ready mode when its owner is awake and in a lent state when the owner is asleep. This figure highlights the fact that this described method is applicable to extremely short term lending events. In fact, if the DLI operation is extended globally then “while-you-sleep-lending” over the globe all by itself could support large long term loans since when one of us sleeps the other is awake, and vice versa.

FIG. 8 DLI Fills in when No Lender is Found

This figure shows a loan that is being satisfied by a succession of lenders L1, L2, L3—after which the DLI was unable to locate a matching lender, so with no other choice the DLI used its own money (from a reserve fund kept specifically for that purpose) to support the loan, while looking for a fitting lender. Soon enough lender L4 is found and pays the loan amount. This payment goes to DLI which beforehand paid the same amount to L3. L4 is followed by L5 and the loan is completed without incident. The emergency intervention of the DLI kept the case smooth and without any incident.

FIG. 9 72 Atomic Lenders Serve a Single Borrower.

The figure shows a borrower, borrowing an amount B for a period of time T. This loan event is supported by 72 “atomic lenders” each lending a small amount x for a short period δ. The loan amount B is shown as vertical that is divided to 12 parts since. 12×=B. The duration of the loan T is shown as a horizontal line that is divided to 6 periods of δ: 6*δ=T. Each atomic loan is shown as one of the 72 rectangles that fit the big rectangle of B*T.

FIG. 10 Risk Management

This figure shows how a loan of sum B extended for a period of time T is supported first by 20 atomic lenders who cover the loan up to the beginning of the last δ period. The last δ period is shown to be served by sub-atomic lenders who each lends for a period of δ an amount x/4. Therefore in the event that the borrowers defaults, and the digital lending bank (initiative) is not covering the loss, the loss is spread in this case to 16 sub-atomic lenders, each loses only ¼th of its loan (x).

Such subatomic division is only necessary for the last δ since only then the borrower has to repay the loan. Earlier atomic lenders get their loan repaid from the next lender. So atomic lender y gets their loan paid by atomic lender w, and w gets their loan repaid by atomic lender z. The figure shows how atomic lenders a, b, and c are each allocating ¼ of their atomic loan to fit into the support of the B, T loan shown.

FIG. 11: Lending Flexibility

This figure shows the power of Loanchain in terms of lending flexibility. Part A shows the case where a lender lends a sum of money for the period T=6δ. If at any point before T is ending the lender needs the money, he or she have no way of getting it because the borrower is not obligated before the end of the period. Part B shows the case where the lender lends the same amount of money but in the Loanchain procedure, namely after every period δ the lender gets their loan back and immediately loans it again. The net result for the case in part B as the same as in case A.

Case C shows the situation where the lender needs the money after 4 δ period, so when the money in delta d is returned to the lender, they do not put it back to lend, rather they stop the lending. The borrower will have to be served by another lender. The LMM will set rules as to how early the lender will have to notify the LMM that the atomic loans for delta e and f are withdrawn, to give LMM time to find another lender.

In general there are many more lending offers that borrowing offers, because a lender does not need to know much ahead of time if their money is used while a borrower needs a committed answer if it is positive.

Part D shows the case where the lender withdraws his offer for delta b and c, resume their offer for delta d and e and cuts it off again for delta f.

FIG. 12 Atomic Loan Matching

This figure shows how three lender L1, L2 and L3 are serving three borrowers B1, B2, and B3 as managed by LMM. Lender L2 offers to lend at time t=0. They serve borrower B1 and B3 who need their loan at t=0 (see dotted lines showing atomic loan matching from lender to borrower). At t=1 L1 pitches in, serving all three lenders. L3 participate in the lending at time point t=2, serving B2 and B3.

FIG. 13: Loanchain Lending Versatility

This figure shows 3 borrowers B1, B2, B3 are fully satisfied by three lenders L1, L2, L3. The lenders offer more lending capacity then the borrowers demand. In total the three borrowers required 12+32+12=56 atomic loans. The three lenders offer many more atomic loans, only 56 of them are matched to borrower's requirement, the rest are not taken, or in other cases matched to other borrowers.

FIG. 14 Loanchain App Screen

This figure shows a screen of a Loanchain app: the amount loaned is shown, the time left before the loan is returned 8 hr and 12 minutes. The loan was lent on a 36 hours basis. Its current reloan status is YES, namely after the loan is returned to the lender it is immediately reloanable. The lender has the option to change the reloan status to NO.

### 1.0 INTRODUCTION

Distributed Digital Lending creates a lending-borrowing marketplace of global proportions, with all the inherent advantages thereto. Run by a virtual digital bank, VDB, serving as an activation organization, also referred to as the Digital Lending Initiative, DLI, which prospectively will rise to become the bank of the future. Lenders and borrowers alike will approach the DLI placing their terms. The DLI will negotiate with anyone knocking on their doors, and with some of them come to terms, enlisting them as customers. The community of lenders and the community of borrowers will be matched to satisfy both and keep the DLI profitable. A classical bank collects the money then manages as its owner, the DLI simply matches the community of lenders with the community of borrowers to satisfy both. It is more direct and it is friction free.

There are no inherent limits, not to the number of lenders playing, nor for the number of borrowers, not to the sums of money exchanged, not to the durations of the loans, not to the lending, nor to the borrowing interests. A normal bank offers various savings plans where money traders are lured to deposit their funds for the bank to use the money to pass to borrowers. These plans are rigid and few. With DLI a borrower will approach the DLI saying: “I need a loan of size $B′, for a period of time T′_{b} days, to start on day t′_{bstart}, and I am prepared to pay an annual simple interest of b′%.” The DLI will counteroffer and negotiate with the would be borrowers and in many cases settle on a loan of B, for a period T_{b} to start on t_{bstart}, and be paid for with an annual rate of b %.

At the same time a would be lender will approach the DLI and say: I am willing to lend you an amount of $L′ for a period of T′ₗ days to start on t_{l start}′, and my price for this loan will be. l′% for a simple annual rate. The DLI will negotiate with this lender and with some such lenders agree on a loan L for a period of time Tₗ, to start on day tₗ, and to be paid for per an annual interest rate % l.

The DLI will manage the initiative planning for the lists of engaged borrowers and engaged lenders, per their individual terms to be such that both lenders and borrowers get what they bargained for, and the DLI nets a profit for its service.

No rigid deposits options, no need to use a traditional bank. Each trader holds their money in their preferred place, including in their individual computing device. All in all the terms are set by the forces of supply and demand.

The global scene will witness several competing DLIs, (competing virtual banks) which is also good for the market.

While the DLI will apply to all lending-borrowing situations, it offers a unique capability for money at rest. Hundreds of billions of dollars are resting in accounts that bear no interest. Their owners keep their money there because of liquidity concerns. The normal depositors plans by the banks don't apply to such instant spending-ready money, however DLI will reach out to every resting dollar, and activate it to bear interest without interfering or affecting the instant spending readiness of the money owner. Money in rest is traditionally benefitting the banks. But today using digital money technology, this period of rest can be pivoted to benefit the owner of the resting money.

What keeps money at rest from benefitting its owner? It is finding a matching borrower. Borrowers flock to the bank. The bank serves them based on the statistical behavior of the bank depositors and pockets the price the borrower pays for the loan.

These two aspects, access to the money holder and access to the money needy can now be claimed by any cyberspace initiative. Today money owners can shift their money from accounting books in the bank to cyberspace where instead of the bank's vault, a cryptographic wall is being used. Digital money is openly listed on a public ledger while the identity of the owner is cryptographically protected. A properly veiled account owner can then raise a flag saying: “I need a loan”, while owners of resting cyber account may declare “I am prepared to lend some or all of the money right now and for a certain period, and no longer. Both the borrowers and the lenders may be identity protected. It is a more complicated proposition to keep the borrowers with a veiled identity for reasons of risk management. However the borrower may prove ownership of an illiquid asset for which using BitMint ownership sharing claim check, a portion thereto can be given as collateral, while keeping the identity hidden.

We consider a digital lending initiative, DLI, or alternatively regarded a Virtual Digital Bank, VDB, as the repository, the hub, not where the money aggregate, rather where all postings are sent to, by would be borrowers and would be lenders, and where the lenders and borrowers will be matched. The DLI will figure out how much money is being needed to be loaned versus how much money is available to be lent. The posting borrower will also declare what interest they are prepared to pay for the desired loan and the lender is stating what interest they demand. The DLI will profit from the margin between the interest paid by the borrower and the interest paid to the lender.

The key to the work of the DLI are two complementary operations: loan build up, and loan breakdown. The DLI will practice both to run this loan operation effectively.

Loan build up refers to assembling money from various lenders to match one larger loan request by a would be borrower. Loan breakdown refers to breaking down a lending-ready amount to service various smaller loans.

### 1.1 LITERATURE SURVEY

As references [1-3] show, digital money technology is advanced enough to carry out lending and borrowing at any volume, but the field literature [4-10] points out to limited practice. Africa takes the lead, driven by necessity. None of the literatures or solutions is practicing loan build up as described here. This technology is patent pending.

### 2.0 LOAN MATCHING: PROCEDURE AND METHODOLOGY

When an amount of money X is loaned from a lender to a borrower for a period of time T, then a loan event has happened. A match was found between a borrower B* who agrees to pay an annual percentage r % for the benefit of having the loan, and a lender, L* who agrees to offer the loan, and be paid for it an amount commensurate with an annual interest of p %.

The gap (r-p) reflects the gain of the loan match maker. (the digital landing initiative).

We consider a situation where over a reference period of time, Tᵣ, a loan match maker, LMM is asking for would be borrowers and would be lenders to inform it of their wishes.

A borrower will say: “I wish to borrow an amount B for a duration T_{b}, starting at date/time point t_{b1}, and I am willing pay for it at an annual rate r %.”

A lender will say: “I wish to lend an amount L for a duration Tₗ, starting at date/time point t_{b1}, and I am setting my price for the loan to be p % at an annual rate.”

At any given point of time t, there will be N_{b}(t) would be borrowers, and Nₗ(t) would be lenders. Each borrower and each lender came up with their own set of parameters for amount, duration, start time, and interest payment percentage (rate). The task before the aspiring loan match maker is to match lenders with borrowers so that few as possible borrowers will be left without a loan and few as possible lenders will be left without a borrower.

For simplicity, per the following analysis, we assume that the match maker is fixing the values of r, and p—the paid and earned interest rates, to insure profitability for the matchmaker. So now all the participants comply.

We define a loan match variable, M, as the multiplication of an amount X that is being loaned/borrowed for time duration T:

$$M = X T$$

We can set up a unit for loan matching, for example $1000*1 day will be one option, namely $1000 loaned for a day. Or finer levels. $100*1 hr, for very short very small loan events, or the opposite, much larger: $10,000*30 days, as is convenient.

Payment for the loan and earning from the loan, as well the loan matchmaker profit from the matched loan all are proportional to the match unit M=XT.

Similarly we define the borrowing load:

$${Q}_{b} = \sum {B}_{i} * {T}_{b i} .$$

where the summation is over all the N_{b} borrowers. Namely: summations of the individual requested loan amounts. B₁, B₂, . . . time the loan durations. T_{b1}, T_{b2}, . . . .

Similarly we define the lending load, Qₗ

$${Q}_{l} = \sum {L}_{i} * {T}_{l i} .$$

where the summation is over all the Nₗ lenders. Namely: summations of the individual offered loan amounts. L₁, L₂, . . . time the loan durations. T₁₁, T₁₂, . . . .

Both summations are conducted over a reference frame, Tᵣ, and include posted borrowing requests and posted lending offers that start and conclude inside the reference period.

Note that both the would be borrowers and the offering lenders submit their requests and statement as posting delivered to the attention of the DLI. There is a built in advantage for sending all the postings to the DLI and not making them public. If made public then individual borrowers and individual lenders will get together to a deal that may be unfair or suboptimized to one party or both, and it will deny the lenders the financial security offered by DLI. Optimized loan build up from a large set of postings and optimized loan breakdown to a large set of counter postings is a complex mathematical task, best conducted by the DLI. The DLI profit depends on the amount of matched loans so it is in its interest to seek optimized matching from the available posting.

Since a loan match requires that every dollar offered for loan for every hour, is matched by a requested dollar to be borrowed for one hour, we can write the basic matching formula:

$${M}_{best} = Min ( {Q}_{l} , - {Q}_{b} )$$

However, the starting date for the various postings can be such that the maximum match per a given combined load from borrowers and lenders will be less that the ‘best’:

$${M}_{m ax} \leq {M}_{best}$$

The basic matching formula suggests that any gap between the borrowing load and the lending load is a waste, the extra load will not be served. It is therefore that match making operation will apply the power of the market—supply and demand—to come as close as possible to equilibrium: Q_{b}=Qₗ.

The power of supply and demand in cyberspace can be applied without any friction, ignoring all separating factors, like nationality and distance.

If we have Q_{b}>Qₗ then one increases the value of % p and % r, so lending becomes more tempting and borrowing more prohibitive.

If we have Q_{b}<Qₗ then one reduces the value of % r and % p so that borrowing becomes more attractive and lending becomes less attractive.

Since all are interested in minimizing waste, all parties seek an objective optimization between r % and p %. In the case where several DLI are in competition, they will compete on who offers the smallest gap between r % and p %.

We discuss below the basic procedures for match making and the AI empowered procedures to improve the results.

### 2.1 BASIC MATCHING PROCEDURE

The operation is driven by borrowers because, a borrower's request by default should be accepted, or rejected as is, while a lender posting can be partially taken.

Borrowers postings are examined per their start date, the earlier get attention early.

The matchmaker looks for lenders with posting fit into the borrower's start day, at any amount. The borrower's requested loan amount is built from available lenders who wish to lend a lesser amount, or from a lender with proper timing that wishes to lend a larger amount. All the lenders that assembled to service this early borrower are paying the money directly to the borrower. (in practice the money may go from the lender to the match maker (the virtual digital bank) from where it goes to the borrower—in both cases using the digital cash instant transaction like in BitMint*LeVeL.)

When the entire requested loan is fit with proper lender's postings the first step is complete. The requested loan is digitally paid to the borrower. The borrower can use the BitMint digital money as is, or redeem it against legacy dollars, per their choosing. After the full amount of the load has been paid to the borrower, there are various time points where the matched lenders have finished their offered duration, and before that happens the match maker needs to find a proper lender to take over the lender that expects its money back before the loan is due. A given first lender L₁ is finishing its lending mission at time point t₁. When t₁ comes to pass the match maker must be ready with another lender, L₂ whose proposed loan is at least the amount serviced by L₁. The replacement lender L₂ pays the amount serviced by L₁, X, but not to the borrower, rather to L₁. This concludes the participation of L₁ who made his lending and got his money back after the specified lending time. The earned interest will be paid later by the match maker.

Next the match maker watches for the next time point where any of the active lenders that is part of the group of lenders who support this borrower reaches its end of lending time, while the borrower's time demand is much longer. At that next time point the match maker will have to be ready with a new lender with proper terms. This new lender will pay the previous lender the amount the previous lender lent, and so again the retiring lender gets it money back at the time desired, being unaware that this lender is part of a loan match build up assembled by the match maker.

### 2.1.1 Continuity

Loan requests with long term durations will require lenders with long term lending offers. Alas, the edge of this DLI is that it captures short term lend offerings and builds them up to a long term loan request. The dilemma of the lender is that they face uncertainty regarding future surprises when cash and liquidity will be sorely needed. If they have their cash being lent out they are at a loss. That is why lenders are reluctant to tie up money for long periods, but prefer shorter periods. These short periods may sequence up to a long period equivalent, but with the advantage of being able to get the money out throughout the long period. It is a better risk picture. Traditional banks find it hard to work with such short term lending. This DLI solution claims an advantage by opening up a whole new market based on short term lenders that engage their money through BitMint fast, irrevocable money transfer protocols. (These protocols are well defined in the prior patent applications preceding this application). These lenders typically can offer to lend now or soon, but are reluctant to commit for a lending at a point far into the future. The DLI then needs to close the gap between the most desired loans from borrowers—long term loans—and the most desired lending from lenders—short term loans offered in the here and now.

To assure a borrower that their loan request for the requested loan time T_{b} will be satisfied, the DLI will have to rely on (i) a credible estimate of lending offerings to be posted long into the future, and (ii) a financial backup capacity to keep the operation going during periods where lending offering are too meager.

The DLI will need to promote the business to secure constant stream of lending offering. The DLI will have to come up with credible predictions as to the future state of lending offering. The DLI will want to rely on AI capability to predict future lending offering. Still, fluctuations will occur, and the DLI must be ready with a financial shock absorbing capacity—ready to use cash, to serve as a lender of last resort to uphold a long term loan commitment the DLI made to a long time borrower.

In the beginning the DLI will need to be ready with a lot of lending capacity on its own. But as the word goes out and lenders are aware of the attractive options to let one's money work for one while one sleeps, more and more ready lenders will come forth and will make it less necessary for the DLI to pitch in its own money.

### 2.2 AI Empowered Matching Procedure

The complexity of matching hard to predict streams of postings from borrowers and lenders alike, makes the goal of optimal loan matching into a typical AI mission.

To prepare the data for AI, the DLI will keep record of the stream of postings over time. The overall time line will be divided to reference periods. R₁, R₂, . . . . The postings that were submitted fully within a reference period will be analyzed “post mortem” to determine the best matching that could have been achieved. This M_{best} value would be compared to the de facto M values achieved within each reference period. If they are similar then no need for AI boost. If not then the data for the growing number of reference periods will be given as raw material for AI supervised learning in order to find pattern with which to build a matching strategy with high matching score. This AI reference engine will become more effective the more reference periods there are to be analyzed. If the climate of the postings will change then the AI inference will track it by giving more weight to recent reference period relative to older ones.

If a market is serviced by more than one DLI then the various DLI will compete as to how well they use AI to increase the efficacy of the loan matching operation.

### 2.3 ELASTICITY

Given a situation where the B postings and the L postings are not in good match, it is advisable for the DLI to negotiate some changes in the terms. To check if a different sum will be Ok, to check if the requested or stated duration can be modified a bit, to check if the starting date can be different. And of course to re-negotiate interest rates. Some postings can come with a lot of elasticity as to such changes, and others not.

It is a role suitable for AI to propose a negotiation strategy. The DLI can offer better rate in exchange of terms elasticity.

### 3.0 THE LOAN BUILD UP PRINCIPLE

A bank aggregates its deposits and organizes its borrowers. The DLI will need similarly achieve access to both the supply and the demand side of the transaction. The DLI will announce its cyber presence and invite would be borrowers and would be lenders to post their propositions.

Borrowers have no issue of security so they are expected to flock to whoever gives them the loan on better terms.

On the supply side the community of money traders naturally keeps at a fully liquid state only a small portion of their money holding. The majority is tucked well and deep into various interest bearing and risk gaming programs. The target of the DLI is to compete with traditional banking on the money regularly used in liquidity constrained situations. But its first move may be to address the liquid funds that are being exploited by the banks, and make no interest to their owners. We refer here to payment-ready money. Now typically people and businesses keep some extra funds to handle financial surprises. These are the funds, money at rest, that the DLI is targeting for the first move into this business. Comparatively these are small funds which their holders are prepared to part with for only a short period.

We therefore may see a mismatch between high volume long time loans requests and small volume short term loan offering. The way to handle this mismatch is through the Loan build-up.

We describe ahead the mathematical definition of the loan build up. The principle is illustrated as follows:

A borrower notifies the DLI of their wish to borrow a loan L for a period of t weeks. At the same time t lenders notify the DLI that they are willing to lend an amount L for a period if 1 week. The DLI combines the t lenders with the single borrower as follows: Lender #1 is engaged to lend an amount L to the borrower for a period of one week. When the week is over, lender #2 is engaged to surrender an amount L to the operation. Only that this second L fund (L₂) is not paying to the borrower, rather is paying to the first lender, who thereby receives his loan back a week after it was extended. A week later lender #3 is engaged to bring to the fore a fund L and this time pays L to the second lender who thereby is happy having the deal completed on their terms. On it goes. Each newly engaged lender is paying L to the previous lender.

The last lender is receiving L back after a week, but he receives it from the borrower. The borrower is blind to the fact that his loan was serviced by t lenders. The borrower got a fund L for t weeks, and paid it back. Interest payment is accounted for separately. The last lender is the only one at special risk for not being paid back. The others are at risk if no new lender comes forth.

What happens if each lender #i is ready to lend a loan Lᵢ<L?

In this case the loan L will be divided to several smaller loans, processed in parallel, so that the smaller loans will be covered by the smallest Lᵢ.

The exact matching is described below.

The buildup principle is then to service a big loan for a long time through a sufficient number of smaller loans, each may be for a shorter time.

### 3.1 THE MATHEMATICS OF LOAN BUILD-UP

A borrower Bob wishes to borrow an amount B, borrowing to start at time T_{b}, and end at date and time T′_{b}. The borrowering prospective is prepared to pay an annual plain interest of r %.

The DLI is searching for some n lenders L₁, L₂, . . . Lₙ. These lenders each offered to lend money per the following terms. Amount lended by Lᵢ: lᵢ; lending starts at tᵢ date, and ends at t′ᵢ date, requested interest pᵢ. For i=1, 2, 3 . . . n

The DLI manager may negotiate with the borrower on its terms, and also negotiate with each lender on their terms. Eventually an agreement is reached.

The DLI assemble n₁<n lenders who can start lending at the agreed upon T_{b}. The total amount lent by the n₁ group is. B=Σlᵢ. for i=1, 2, . . . n₁.

Every lender i in the n₁ group for which t′ᵢ is earlier than T′_{b} (t′ᵢ<T′_{b}) will be getting back his loan lᵢ at t′ᵢ by activating another lender, j, where lᵢ≤lⱼ, (where Lⱼ is not in the n₁ group) to pay lᵢ dollars to Lᵢ. Thereby lender Lᵢ finished his service for this loan. This lender lent lᵢ dollars from tᵢ to t′ᵢ, and now is owed by DLI interest.

This ‘replacement of lender’ sequence is used again and again until the full lending case is accomplished. The borrower receives an amount of B dollars from time T_{b} to time T′_{b}, and is billed by the DLI an amount commensurate with interest r %.

The values of r % and p₁, p₂, . . . pₙ are such that DLI is left with a gross profit P_{g} sufficient to cover the operational cost Cₒ and secure a net profit N=P_{g}−Cₒ to make the initiative worthwhile.

Over time a stream of borrowers approach the DLI as well as a stream of lenders. The streams may be in good balance and the operation is smooth.

At times the streams are off balance. There may be more borrowers asking for a loan than lenders willing to extend one. In that case the DLI raises the bar with respect to r %, which is the interest paid by the borrower, which in turn allows DLI to raise the lending rate pᵢ for every potential lender i, to lure lenders to the operation.

At other times there is an edge of offering lenders over a few borrowers. In this case DLI will negotiate lower lending rate p₁, p₂, . . . pₙ and then tempt more borrowers with a lower r %.

The more borrowers and the more lenders the greater the action and the greater the profits for DLI, so DLI will be of interest to advertise the service and reach out far and wide. Since borrowers and lenders don't know each other, they can be matched from across town to across ocean, making the DLI a global operation.

The final negotiations with lenders may be private so that lenders cannot compare rates. Advertised rates normally are made public.

The negotiated interest rate p₁, p₂, . . . pₙ may be graded: the larger the amount, and the longer the lending time, the larger the interest rate because the DLI will have to use fewer lenders to build up a loan. Also a given extended loan can be extended between two or more built-up loans.

### 3.1.1 AI Empowered Coin Breakdown and Coin Build Up

The DLI collects a large number of postings from borrowers and lenders alike. Each posting comes with stated amount, X, a stated duration T, a stated interest rate, r, and a starting date s. {X,T,r,s} The B-posting (from the borrowers), and the L-postings (from the lenders) may be at various degrees of matching.

On one extreme we have the state of zero matching. A simple way for this is when the starting date for the B postings are so much earlier than the starting date for the L postings that no lender can be matched with any borrower.

A full match is the other extreme, a simple way for this to happen is when each B posting has a matching L posting, and the gap between the B interest rate and the L interest rate is sufficient to keep the DLI (the virtual digital bank) operating.

In between are the many states of partial matching. In a partial match some would be borrowers don't get the loan they ask for and some lenders don't get a buyer for the loan they offer. The objective of the DLI is to minimize such waste and extract optimal matching from the dynamic array of posting. We note that every moment new postings appear and old postings become obsolete.

At any given moment of time the DLI is facing an array of B posts and an array of L-posts. The larger the number of the posting and the greater their variety, the more complex is the optimization task, what is more this task needs to be carried out fast enough, so that the plan for time point t, will be action ready before time point t comes to pass.

While an analytic optimization solution is theoretically possible, for large scale matching it is practically infeasible, and that is where artificial intelligence, AI, gets into the picture.

When the DLI starts to operate, the matching is done analytically through a basic routine in which the larger postings are matched with smaller ones. As this proceeds the record of the postings is kept for an AI engine to chew the data and apply its inferential protocols to construct an optimized matching to exceed the efficiency of the analytical match making.

At the next level the AI will develop a negotiation strategy with the borrowers and the lenders alike, for them to agree on slightly different terms than originally proposed in order to increase the matching quality.

### 3.2 LOAN BREAKDOWN

A large lending offering will have to be broken down to serve a variety of small scale, short term borrowers.

Matching will start with looking for borrowers that together will borrow the large amount of lending money to be broken down. Ideally there will be a borrower for every dollar offered to be lent at the time the lending offer is regarded as the start time. The match maker, the DLI, will try to post small borrowers on the larger lending offer. Success is measured by how much money from this lender is lent for how long a time.

Geometrically one can represent a lending offer for sum X and duration T to start at tₛₜₐᵣₜ as rectangle marked on a flat surface where T is the horizontal stretch of the rectangle and X is the vertical stretch, while the rectangle itself is placed on the time line at starting point tₛₜₐᵣₜ.

The objective of the loan match maker would be cover as much as possible from the area of this rectangle with smaller rectangles representing borrowers. The ratio of the covered area (with borrowers) divided by the area of the rectangle, XT, represents the efficiency of the operation, the ratio of rendering the lending offer to an executed loan. The goal of the DLI is to maximize the amount and duration of executed loans because the DLI makes money in proportion of the multiplication of loan amounts times their durations.

### 4.0 THE TRADED COIN

The DLI is based on quick, immediate trade with finality and exposure. This requires a cryptographic coin with a mathematical clarity as to the identity of the owner of each coin at any moment of time. Pre digital payments suffered from stretches of ambiguity and administrative friction which makes short range lending impractical. The BitMint digital coin (LeVeL) is a cryptographic stablecoin with full clarity as to the owner of the coin at each moment and it also offers public exposure for the same. Say then that in order to practice DLI both lenders and borrowers will have to first convert the engaged funds to BitMint coins, then trade with this coins. Similar coins other than BitMint may qualify too.

A lender will be using a computing application that will buy the desired amount of money in BitMint coins, paying with fiat currency. The purchased digital coins will be paid to the DLI manager (DLIM), using the BitMint*Le VeL payment protocol and the DLI manager will then pass the money to the borrower. Alternatively the lender will pay directly to the borrower, if that lender is the first in line, or the lender will pay to the former lender. Such transaction may take place without the lender knowing who the borrower is because the BitMint LeVeL protocol offers complete anonymity to the money traders. Of course, when the regulatory climate forbids this anonymity, it will not happen. When the loan is paid back, the borrower will pay the DLI who will pay the last lender, or the borrower will pay directly to the last lender.

All payments per the protocol are shown instantly on the public ledger with no ambiguity. The borrower will be able to use the loan instantly.

The BitMint*Le VeL transaction is final, and hence the money can be used. by the borrower right away.

The borrower will be able to instantly convert the BitMint digital coins to any other form of money. The exchange rate is fixed. We recall that BitMint coins are considered claim checks for fiat currency.

Participants will need to put forth a ready buy and redeem application for the BitMint digital coins, and keep their coins in their apps for the DLI transactions.

### 5.0 RISK MANAGEMENT

The main risk in any lending business is default. The lenders will manage this risk in various ways:
1. the small steps defense 2. the DLI reputation defense 3. the DLI insurance defense

Lenders choosing to lend small amounts to short terms are risking no more than the small amount lent. Unlike a bulk loan of high amount, here a lender builds up a big sum to lend by lending one small amount after the other, so that if something goes arrear, the loss is minimal. That is the advantage of building up a large loan for extended period of time from successive small loans for short periods of time. Great risk reduction to lenders.

DLI over time will earn a reputation for choosing borrowers carefully so that the risk for lenders is curtailed. Competing DLIs will strive to win more customers (lenders and borrowers) by better vetting borrowers.

The DLI insurance defense is based on it insuring the lenders against default of a borrower. Such insurance can be offered based on effective vetting of the borrowers, or especially, for large loan borrowers on holding a collateral, like banks do. Working in the digital space DLI will be more flexible and more effective with collateral management.

The DLI runs the risk of good faith lawsuits, of insurance default, or business running away to the competition, of small or zero profitability because of a small margins between the paid and earned interests and ill calculation of operational and maintenance cost.

Collateral Management: Bank extend loans by trading non liquid assets against liquid assets. DLI can do the same only better. Let a given borrower have an ownership position for an illiquid asset A of value V. The borrower wishes to take a loan of value L<V. The DLI will then issue BitMint digital coins defined as equity in that asset. A fraction L/V of these coins will be assigned to the DLI. The DLI will contractually have the right to force a sale of the asset, which may be a private sale. The asset may be bought back by the current owner, but L valued coins will be claimed by the DLI in the case the borrower defaults on the loan for which the collateral was taken.

Small Steps Defense: Lenders feel less risk for short term lending. They find right away if anything goes wrong. Therefore one should expect a lot of readiness from account holders to offer lending for short terms. The edge of this method is that it nicely builds a long term match from many short term loans.

The DLI reputation defense: Since there expected to be several competing DLI in any market, then each DLI will be worried about their reputation and hence will try hard to avoid a breakdown of the system and to cover any need with its own funds.

DLI Insurance defense: The DLI could seek insurance protection to enhance its credibility. This will impact its expenses and the gap between two interest rates, p and r, lending and borrowing, and hence the attractivity of the operation.

### 6.0 SCOPE AND OPERATION

Distributed Digital Lending creates a lending-borrowing marketplace of global proportions, with all the inherent advantages thereto. Run by an activation organization, the Digital Lending Initiative, DLI, which may rise to become the bank of the future. Lenders and borrowers alike will approach the DLI placing their terms. The DLI will negotiate with anyone knocking on their doors, and with some of them come to terms, enlisting them as customers. The community of lenders and the community of borrowers will be matched to satisfy both and keep the DLI profitable.

There are no inherent limits, not to the number of lenders playing, nor for the number of borrowers, not to the sums of money exchanged, not to the durations of the loans, not to the lending nor to the borrowing interests. A normal bank offers various savings plans were money traders are lured to deposit their funds for the bank to use the money to pass to borrowers. These plans are rigid and few. With DLI a borrower will approach the DLI saying: I need a loan of size $B′, for a period of time T_{b} days, to start on day t′_{bstart}, and I am prepared to pay an annual simple interest of b′%. The DLI will counter offer and negotiate with the would be borrowers and in many cases settle on a loan of B, for a period T_{b} to start on t_{bstart}, and be paid for with an annual rate of b %.

At the same time a would be lender will approach the DLI and say: I am willing to lend you an amount of $L′ for a period of T″ₗ days to start on t_{l start}″, and my price for this loan will be. l″% for a simple annual rate. The DLI will negotiate with this lender and with some such lenders agree on a loan L for a period of time Tₗ, to start on day tₗ, and to be paid for per an annual interest rate % l.

The lists of engaged borrowers and engaged lenders, per their individual terms will be such that both lenders and borrowers get what they bargained for, and the DLI nets a profit for its service.

No rigid deposits options, no need to use a traditional bank. Each trader holds their money in their individual computing device. (or in a ready to online use bank account). All in all the terms are set by the forces of supply and demand.

The global scene will witness several competing DLIs, which is also good for the market. It is hard to see a role for traditional banking in the new era of digital lending.

### 6.1 LENDERS-BORROWERS BALANCE

Naturally the engaged borrowers and the engaged lenders will have to balance out for the DLI concept to work. The balance of interest refers to the size distribution of the borrowing requests versus the size distribution of the lenders offers. A size S of a loan is measured by the multiplication of the loan amount X times the loan duration, D:S=XD. The price of the loan, p is proportional to its size p=kS. Because p is determined by the amount and the duration.

The following options are all proper:
1. There are few borrowers, but the typical size of their loan is high, while there are many lenders with a typical small size loans.
2. There is a roughly equal number of borrowers and lenders and the loans from both sides are similar.
3. There are many borrowers but their loans is small, while there are few lenders and their loan is large.

Colored DLI: DLI can be implemented over a colored community of borrowers. Say minority small business, or say pharmaceutical startups. Being a special group might incentivize lenders to lend at a lower rate, even perhaps with a negative interest rate.

### 6.2 PURPOSE AND CHARACTER OF THE LOANS

Loans of particular purposes may be treated in a special way. For example loans given to socially important enterprise may be guaranteed by the government so that lenders don't sustain any risk in lending. The character of the loan makes a difference. We focus, for example, on the purpose of the lent money. The first run of the DLI is planned for idle liquid money that normally does not bear any interest. Therefore any interest offered by the DLI will be a net positive to the lender. This is the no-competition zone because banks keep liquid funds in a non-interest bearing accounts. The banks enjoy the resultant profit. One would expect the zero competition zone for DLI to work smoothly and depend only on the level of promotion of the initiative.

DLI will naturally extend itself to compete with legacy banks, aiming at non liquid funds. Legacy banks lure customers to trust them with locked funds for a long range, and be rewarded with high yield. The banks in the US rely on the FDIC to project security, since depositors are most concerned with not losing their money. The DLI will lure its lenders with security through various means.

DLI security offering:
1. screening borrowers 2. DLI guarantee 3. Insured DLI 4. risk matching.
screening borrowers: The DLI will choose borrowers projecting trust, qualified in some way, and then assure the lenders that these borrowers are trust worthy.
risk matching: A high risk borrower is ready to pay a high price for their loan. The DLI will tell the lenders that their money will serve high risk borrowers, and therefore their claimed interest will also be high, to compensate for their risk. And the same on the other end, highly secure borrowers are insisting on paying low interest, and the lenders will comply.

### 6.3 DLI APPLICATIONS

Borrowers and Lenders alike will have to use dedicated DLI applications on their electronic communication devices. These applications will have hand shaking protocols with the DLI and will be programmed to pass BitMint digital coin from one to the other using the standard BitMint payment protocol. We note that however short a lending event is, the money, cash-wise is transferred from lender to the DLI and from the DLI to the borrower or to the previous lender. and vice versa from the borrower to the DLI, and from the DLI to the last lender. All the transactions are listed and are clear on the public ledger for this BitMint coin.

### 7.0 IMPACT AND OUTLOOK

The loan matching procedure described here has a unilateral status for the ‘sleep and earn’ market. Today nobody offers any consistent interest for checking accounts or credit accounts associated with credit cards etc. The billions of dollars that lie in such spend-ready accounts are benefitting the legacy banks. So for this market the DLI will be the only game in town. An aggressive publicity will ensure the great chance of success.

Following such success the loan matching of this methodology will naturally grow to eat away and compete with normal loan making options in banking today. This method here has a big advantage, it relies on the ability of BitMint and similar digital money options to carry out fast instant irrevocable transactions that are necessary for the fast turn around of ‘loan while you sleep’.

Second, this method allows for friction free supply and demand forces to acutely adjust the interest rate at both ends. Competing DLI organizations will apply market forces to setting up their own profits.

There is no reason to put a boundary as to where the DLI will stop and legacy banking will continue. Even mortgage loans where duration is decades can be handled with DLI, of course the financial backup funds to handle temporary shortages of lenders will have to be sufficiently high.

Traditional banks have the FDIC advantage. There is no reason in principle to extend the same protection to DLI. Also DLI could be operated by legacy banks.

While DLI operation requires the DLI to have enough funds at hand to handle crises, such funds are minimal compared to the money turnover of this loan matching operation.

It is conceivable that the DLI will be recognized as virtual digital banks, VDB and replace the legacy banks, all around.

### 8.0 THE INNOVATIVE ELEMENTS

The main Innovative elements in this application are:
1. Atomic Lending 2. Loanchaining 3. Loan Globalization 4. Risk Distribution.

Principles: Unpaid money is useless. Money is not a hammer or an automobile. It has no use except when one wishes to pass it on. It is therefore that in principle one has no reason to hold on to any amount of money—as long as payment is not required. And since loaned money generates money for the lender, there is a built in incentive for money owners to lend their money rather than hold on to it. They only need to insure that they will have their money when they wish to pay it. This invention exploits this lenders' interest by building a global lending-borrowing matching operation constructed from ‘atomic loans’—small amount of money lent over a short period. If a lender wish to be able to pay a million dollar they own within, say 8 hours, then this lender can lend this sum of money for 8 hours at a time. After each 8 hours period the loan will return to the lender, and immediately will be loaned again unless the lender blocks it. This quick shift of money ownership to and from the lender is a feature guaranteed by the applications that are ancestorial to this one, which have been implemented in the payment system LeVeL by BitMint.

Lenders, borrowers, and the organizer of the Loanchain will be involved in ongoing negotiations as to the fee paid by the borrower and the fee credited to the lender. Since several Loanchain companies are expected to rise and compete, the public will be able to compare terms.

### 8.1 ATOMIC LENDING

The lending mechanism used by a bank is too complex for atomic lending. We define atomic loans as loans where the sum loaned is practically as small as desired, and the duration of the loan may be as short as minutes or less. The interest to be earned from such an atomic loan is miniscule, but when atomic loans aggregate the interest rises. By replacing a monolithic loan with a tissue (loanchains in parallel) of atomic loans, the lender, on one hand achieves parity between the two modes, if all goes well, but on the other hand the lender faces a much smaller risk while encountering unexpected negative surprises.

If a lender lends $10,000 for a year to certain borrower, then they run the risk of default, losing their money. If instead the lender lends 100 loans of $100 each, then even if a few borrowers default, the loss is much less than $10,000. If the lender also lends each $100 loan for 1 day, rather than a year then they avoid the risk of having need for the lent money and not having it.

Atomic lending is possible because the money is in digital format where ownership of digital coins is cryptographically established and cryptographically switched instantly—such ownership is on public display 24/7. When a lender L owns a digital coin X, of value X*, the lender then has a payment key Ky that opens the cryptographic vault, Vₗ and passes the money (X) to a borrower, B, who saves the money in his vault, V_{b} which only he can open, using key K_{b}. This transfer of coin X between the vaults happens with electronic speed in cyberspace. The vaults are listed on a public ledger maintained by the digital lending initiative organization. The procedure of moving the money between the cryptographic vaults is the same regardless of how much money changes hands. And because the procedure is so fast, it is readily possible for the borrower to return the money (X) to the lender after a very short time interval δ. In other words digital payment as described above allows for small as desired sums to be lent for a short as desired period—creating an atomic loan.

On its face, as described above this procedure does not make much sense. The lender will get miniscule interest because X* is small and δ is small, and the borrower will not be able to do much with the lent money because again the sum is small and the duration of the loan is so short. Here comes the chaining concept. After a δ time interval, the loan is not returned by the borrower B, but by a standing in line lender L′ who also wishes to lend X* for a short period, say δ. The lender does not care where the money is coming from, the loan process comes to its good end and its little interest accumulates with similar interests from similar instances.

### 8.2 LOANCHAINING

The innovative element in LoanChain is the “chain”. Borrowers wish to borrow large sums, B, for long duration T_{b}. They need B to be large so that they can do what they plan to do and need money for, and they need T_{b} to be long so that they have time to work with B, make money and return B plus interest. Lenders, by contrast, feel more comfortable (sustaining less risk) if they lend small sums, and for short periods. The longer the period they lend their money for, the greater their risk to need this money before the lending period is over, and not having it. This is fundamental dichotomy between lenders and borrowers. This application offers an innovative solution in a form of a chain or rather a set of parallel chains.

The large sum B will be divided to small enough slices b₁, b₂, . . . bₙ, and the time span T_{b} will be sliced into small time intervals t₁, t₂, . . . tₘ. Such that m*n small lenders will serve the one large B loan for a long duration of T_{b}. Some or all of these lenders may be one and the same.

This innovation enables atomic lending and makes money to money holders who keep their money in interest not bearing accounts. It generates lending-borrowing matching that did not exist beforehand. It offers a clear social benefit.

### 8.3 LOAN GLOBALIZATION

The owners of the cryptographic vaults listed in the public ledger maintained by the digital bank are not identified (unless regulatory required). They can come from all corners of the globe. While it may be important to the digital bank (the digital payment initiative) to evaluate the credit worth of a borrower, there is no need to check any good behavior on the part of the lender, so the Initiative (the LMM) will not mind where the money is coming from. The anonymity of the owners will induce lenders from all around the world to come forth and make money from their available funds. This globalization will give more flexibility to the AI engines vying to optimize the loan matching. In particular globalization will exploit the time zone differences around the globe.

While people are asleep they don't need access to their money, so it would not be a big risk to lend ready money overnight. Overnight in one part of the world is full busy day in another part, where money is very useful. Globalization will offer a good time zone differences match.

### 8.4 RISK DISTRIBUTION

A borrower that borrows money X for duration T may be served by n lenders, each lending amount X for an interval of time tᵢ, such that when these n intervals are stretched one following the other, they mark the full loan period, T:

$$T = {t}_{1} - {t}_{2} - {t}_{3} - … {t}_{n}$$

The first (n−1) lenders have their loan returned by the next lender. Since the digital bank maintains the flow of lending offers, there is little risk that the loan will not be returned. Only the n-th lender faces the risk of that borrower defaulting on their loan. (note: here in we use the terms ‘digital bank’, ‘loan chain initiative’, ‘digital lending initiative’, and ‘loan match maker’ interchangeably.)

That means that for any defaulting borrower the chance for a lender to face this default is 1/n. What happens in case of default depends on the rules of the digital initiative. The initiative may be covering for the default, (on its own or through insurance, perhaps even federal insurance), or the hapless lender sustains the loss.

To further mitigate the risk for lenders the match maker can divide the loan X to a small risk portion Xᵣ, and a no-risk (settled) portion. Xₛ:X=Xᵣ+Xₛ. The Xₛ part will be allocated to non-terminal steps (namely to make the loan in one of the n−1 intervals, per the description above), and allocate the risk portion Xᵣ to terminal steps. This would reduce the risk of default per lender by Xᵣ/X times the nominal risk of default.

### 9.0 OPERATIONAL SUMMARY

Presenting a method for exercising an “atomic loan” which is a loan of a small as desired sum of money x, lent for a short as desired time interval δ, the lender is regarded as “atomic lender”;
(i) offering the atomic lender to extend a loan with well controlled risk, and
(ii) enabling a multitude of atomic lenders (n) to be organized as “loanchains” to together lend a borrower B*, a large as desired sum B for a long as desired time T and thereby allowing liquid funds to be bearing interest.

Atomic lending is carried out through digital money where sums of money are kept in cryptographic vaults for which only the owner of the money has a cryptographic key. and where payment amounts to passing the money from a vault for which the current owner has a key, to a second vault where only the new owner has a key, and where the vaults are listed on a public ledger; the loanchain is organized by a “Loan Match Maker,” LMM, who gathers atomic lending propositions from the public, and is building chains of n atomic loans to be activated in parallel and in succession to provide the borrower B* with a borrowed loan B for a period of time T

The borrowed sum B is divided to p parts, each of value x, so that B=xp, and the loan period T is divided to q time interval such that each time interval is δ, and where T=q*δ,
thereby n=pq atomic lenders can together lend the amount B for a period T,
a first group of p atomic lenders will lend each a sum x at time t₀ which is the time the loan is activated, this will generate a sum px=B of money that will be paid to the borrower, B*;
at time point t₁ where: t₁=t₀+δ, a second group of p atomic lenders will each lend an amount x,
the second group of atomic lenders will be matched one on one with the first group of p atomic lenders so that each member of the first group will have their loan returned after a period of δ;
at time point t₂=t₁+δ=t₀+2*δ, a third group of p atomic lenders will each lend an amount x,
the third group of atomic lenders will be matched one on one with the second group of p atomic lenders so that each member of the second group will have their loan returned after a period of δ;
a 4th group of p atomic lenders will similarly return the loans of the 3rd group, and so on until the q group of atomic lenders which returns to the members of the (q−1) group, to each a sum of x;
the borrower B returns the borrowed sum B at time point t_{q}=t₀+q*δ=t₀+T, and this returned loan is divided to p sums of x each, where each of the p members of group q is thereby receiving their loaned amount x which has been loaned for δ time;
borrower B* is charged interest I_{b} for the loan, the Loan Match Maker, LMM, is subtracting operational expenses Iₒ and profit Iₚ from. I_{b} and divides the remainder

$${I}_{r} = {I}_{b} - ( {I}_{p} + {I}_{o} )$$

to the n=pq atomic lenders, giving each atomic lender an interest payment of iₗ=Iᵣ/n for participating in the loanchain operation.

Also, atomic lenders are ‘fused’ to become ‘molecular lenders’, where each molecular lender is lending a sum of money of g*x where g is a positive integer, and that money is being lent for a period of time h*δ, where h is a positive integer, a molecular lender is equivalent to gh atomic lenders.

In addition the LMM is establishing a “loanchain website” wherein borrowers post the amount B they wish to borrow, the duration of the loan, T, the interval of dates when they need the loan to start, and the interest rate, p % they are willing to pay for the loan; prospective lenders will post on the loanchain website the amount L (a multiple of x) they are prepared to lend, the time W of the loan duration (a multiple of δ), the interval of time points in which the loan can be exercised, and the interest rate r % they ask to be paid for the loan, the LMM will match lenders postings with borrowers' postings, activate the lending operation in claim 1;
the LMM will negotiate with posting lenders and posting borrowers the interest rates the borrowers will pay and the interest rates lenders will receive, these rates will allow the LMM to pay for its operational cost and make a profit.

In the case wherein the LMM cannot secure an atomic loan to pay back a current atomic lender, the LMM will make the atomic loan, repeatedly until a lender is found to replace it.

The LMM prepares for situations where a borrower defaults on his obligation; options:
(i) the LMM pays the lenders for which there are no next lenders to pay them,
(ii) the LMM buys insurance to cover defaults,
(iii) the lenders that expected the defaulting borrower to pay them are suffering the loss,
(iv) combination of the three options above.

The LMM collects the interest payments from the borrowers, subtracts its operational cost, subtracts its profit, and divides the remainder among the lenders each per their loan.

The LMM is practicing risk management procedure to handle a default borrower as follows:

The atomic sums, x for the last δ stretch, are divided to s sub-atomic sums y, x=ys, and each sub-atomic sum is lent by a different lender, this will spread the default to p*s lenders where each affected lender will lose only 1/s of its atomic loan.

This method is used for enabling a lender to mitigate their lending risk by replacing a loan of sum L lent for a period of time T with a set of parallel chains of n atomic loans where L=p*x, T=q*δ, n=pq, where the n atomic loans are spread among a multitude of borrowers.

Also, a lender of sum L=p*x for period T=q*δ will be allowed every period of time δ to change the value of L up or down. If the lender increases the value of the loan, L, then LMM will find additional borrowers to take the added loan sum. If the lender reduces the value of the loan, L, then the LMM will find other lenders to pay the borrower or the current atomic lender that was slated to receive the withdrawn atomic sum x.

### 10. REFERENCE

1. “Tethered Money” G. Samid, Elsevier 2015
2. “Digital Finance: Cash, Credit, And Investment Instruments In A Unified Framework (Bitmint)” U.S. Pat. No. 11,107,1563.
3. “Digital Transactional Procedures And Implements”. U.S. Pat. No. 9,471,906
4. “Effects of Digital Loans on Financial Performance for Commercial Banks Listed” http://erepository.uonbi.ac.ke/handle/11295/166329
5. “Fintech and big tech credit: Drivers of the growth of digital lending” https://www.sciencedirect.com/science/article/pii/S0378426622003223
6. “Digitalization of financial services in European countries: Evaluation and comparative analysis”. https://www.ceeol.com/search/article-detail?id=977868
7. “Digital transformation and costumers services in emerging countries: Loan prediction modeling in modern banking transactions” https://link.springer.com/chapter/10.1007/978-3-030-90618-4_32
8. “LendPal-Borrow & Lend Money+Items to Friends 4” https://apps.apple.com/us/app/lendpal-borrow-lend-money-items-to-friends
9. “WeLend,” https://www.welend.hk/en
10. “Digital credit in Kenya: A survey of costs, uses and borrowers considerations in relation to loan uptake”

What is claimed is:

1. A method for exercising an “atomic loan” which is a loan of a small as desired sum of money x, lent for a short as desired time interval δ, the lender is regarded as “atomic lender”;
(i) offering the atomic lender to extend a loan with well controlled risk, and
(ii) enabling a multitude of atomic lenders (n) to be organized as “loanchains” to together lend a borrower B*, a large as desired sum B for a long as desired time T
and thereby enabling liquid funds to be bearing interest; and competing against less efficient lending solutions;
atomic lending is carried out through digital money where sums of money are kept in “cryptographic vaults” for which only the owner of the money has a cryptographic key. and where payment amounts to passing the money from a vault for which the current owner has a key, to a second vault for which only the new owner has a key, and where the vaults are listed on a public ledger;
the loanchain is organized by a “Loan Match Maker,” LMM, which gathers atomic lending propositions from the public, and is building p chains of atomic loans which are a succession of q atomic loans; the p chains of atomic loans are activated in parallel providing the borrower B* with a borrowed loan B for a period of time T;
the borrowed sum B is divided to p parts, each of value x, so that B=xp, and the loan period Tis divided to q time interval such that each time interval is δ, and where T=q*δ,
thereby n=pq atomic lenders together lend the amount B for a period T,
a first group of p atomic lenders will lend each a sum x at time t₀ which is the time the loan is activated, this will generate a sum px=B of money that will be paid to the borrower, B*;
at time point t₁ where: t₁=t₀+δ, a second group of p atomic lenders will each lend an amount x,
the second group of atomic lenders will be matched one on one with the first group of p atomic lenders so that each member of the first group will have their loan paid back by a member of the second group, the pay back happens after a period of δ;
at time point t₂=t₁+δ=t₀+2*δ, a third group of p atomic lenders will each lend an amount x,
the third group of atomic lenders will be matched one on one with the second group of p atomic lenders so that each member of the second group will have their loan paid back by a member of the third group, the pay back happens at time point t₂;
a 4th group of p atomic lenders will similarly return the loans of the 3rd group, and so on until the q group of atomic lenders which returns to the members of the (q−1) group, to each a sum of x;
the borrower B* returns the borrowed sum B at time point t_{q}=t₀+q*δ=t₀+T, and this returned loan is divided to p sums of x each, where each of the p members of group q is thereby receiving their loaned amount x which has been loaned for δ time;
borrower B* is charged interest I_{b} for the loan, the Loan Match Maker, LMM, is subtracting operational expenses Iₒ and profit Iₚ from. I_{b} and divides the remainder
$${I}_{r} = {I}_{b} - ( {I}_{p} + {I}_{o} )$$
to the n=pq atomic lenders, giving each atomic lender an interest payment of iₗ=Iᵣ/n for participating in the loanchain operation.

2. The method in claim 1 wherein atomic lenders are ‘fused’ to become ‘molecular lenders’, where each molecular lender is lending a sum of money of g*x where g is a positive integer, and that money is being lent for a period of time h*δ, where h is a positive integer, a molecular lender is equivalent to gh atomic lenders.

3. The method of claim 1 wherein the LMM is establishing a “loanchain website” wherein borrowers post the amount B they wish to borrow, the duration of the loan, T, the interval of dates when they need the loan to start, and the interest rate, p % they are willing to pay for the loan;
prospective lenders will post on the loanchain website the amount L (a multiple of x) they are prepared to lend, the time W of the loan duration (a multiple of δ), the interval of time points in which the loan can be exercised, and the interest rate r % they ask to be paid for the loan,
the LMM will match lenders postings with borrowers' postings, activate the lending operation in claim 1;
the LMM will negotiate with posting lenders and posting borrowers the interest rates the borrowers will pay and the interest rates lenders will receive, these rates will allow the LMM to pay for its operational cost and make a profit.

4. The method of claim 1 where in the case wherein the LMM cannot secure an atomic loan to pay back a current atomic lender, the LMM will make the atomic loan, repeatedly until a lender is found to replace it.

5. The method in claim 1 wherein the LMM prepares for situations where a borrower defaults on his obligation; options:
(i) the LMM pays the lenders for which there are no next lenders to pay them,
(ii) the LMM buys insurance to cover defaults,
(iii) the lenders that expected the defaulting borrower to pay them are suffering the loss,
(iv) combination of the three options above.

6. The method of claim 1 wherein the LMM collects the interest payments from the borrowers, subtracts its operational cost, subtracts its profit, and divides the remainder among the lenders each per their loan.

7. The method of claim 1 where the LMM is practicing risk management procedure to handle a default borrower as follows:
The atomic sums, x for the last δ stretch, are divided to s sub-atomic sums y, x=ys, and each sub-atomic sum is lent by a different lender, this will spread the default to p*s lenders where each affected lender will lose only 1/s of its atomic loan.

8. The method in claim 1 used for enabling a lender to mitigate their lending risk by replacing a loan of sum L lent for a period of time T with a set of parallel chains of n atomic loans where L=p*x, T=q*δ, n=pq, where the n atomic loans are spread among a multitude of borrowers.

9. The method of claim 1 wherein a lender of sum L=p*x for period T=q*δ will be allowed every period of time δ to change the value of L up or down,
if the lender increases the value of the loan, L, then the LMM will find additional borrowers to take the added loan sum,
if the lender reduces the value of the loan, L, then the LMM will find other lenders to pay the borrower or the current atomic lender that was slated to receive the withdrawn atomic sum x.
